(19) United States
(12) Patent Application Publication
(10) Pub. No.: US 2007/0184673 A1
(43) Pub. Date: Aug. 9, 2007

(54) BONE SCREW FOR MEDICAL TREATMENTS

(75) Inventor: Jae-Il Park, Aansan-si (KR)

Correspondence Address: KNOBBE MARTENS OLSON & BEAR LLP, 2040 MAIN STREET, FOURTEENTH FLOOR, IRVINE, CA, 92614, US

(73) Assignee: JEIL MEDICAL CORPORATION, Seoul (KR)

(21) Appl. No.: 11/668,372

(22) Filed: Jan. 29, 2007

Related U.S. Application Data
(63) Continuation of application No. PCT/KR04/01886, filed on Jul. 27, 2004.

(51) Int. Cl. H01R 39/00

(52) U.S. Cl. 439/15

(57) ABSTRACT

The disclosure relates to a bone screw for medical treatments. On one hand, the disclosure relates to an anchor screw for orthodontic treatments, which has a head portion enabling tightening or unscrewing of the anchor screw and simultaneously allowing an orthodontic device such as a wire to be hung thereon. An anchor screw for orthodontic treatments includes a threaded portion to be inserted through rotation into the palatine bone so as to form a female thread therein and to fasten the screw to the palatine bone, an intermediate portion extending from the threaded portion and having an increasing diameter, and a head portion extending from the intermediate portion. The head portion has a predetermine width while extending from the intermediate portion and protruding in a direction of a central axis of the anchor screw, and includes a pair of parallel flat surfaces spaced apart by a predetermined distance from the central axis of the anchor screw to tighten and unscrew the anchor screw, at least one opening formed to penetrate through the pair of flat surfaces so that an orthodontic device including a wire can be installed therein, and an insertion slit extending from an inner surface of the opening facing the threaded portion to the outside so that the opening can communicate with the outside.

### CROSS-REFERENCE TO RELATED PATENT APPLICATIONS

This application is a continuation application under 35 U.S.C. § 365(c) of International Application No. PCT/KR2004/001886, filed Jul. 27, 2004 designating the United States. International Application No. PCT/KR2004/001886 was published in English as WO2006/011693 A1 on Feb. 2, 2006. This application incorporates herein by reference the International Application No. PCT/KR2004/001886 including the International Publication No. WO2006/011693 Al in their entirety.

### BACKGROUND

1. Field

The present invention relates to a bone screw for medical treatments. On one hand, the present invention relates to an anchor screw for orthodontic treatments, which has a head portion enabling tightening or unscrewing of the anchor screw and simultaneously allowing an orthodontic device such as a wire to be hung thereon. On the other hand, the present invention relates to a bone screw for medical treatments, which can be used as an anchor screw for orthodontic treatments as well as a screw for osteosynthetic treatments, and more particularly, to a bone screw for medical treatments, wherein a threaded portion of the bone screw fixedly inserted into a bone is provided with a plurality of inclined sections to increase a fastening force between the screw and the bone with the screw inserted thereinto.

2. Discussion of Related Technology

U.S. Pat. No. 6,669,473 entitled “Anchor Screw for Orthodontic Treatments” discloses an anchor screw for orthodontic treatments, which comprises a lower threaded portion inserted into and fastened to a bone, a substantially cylindrical central portion, and an upper portion with a screw-tightening means. The central portion has a reduced diameter zone for fixing an orthodontic device. The reduced diameter zone is further provided with two parallel flat surfaces for preventing rotation of the orthodontic device, and at least one opening formed to traverse an axis of the screw so that the device such as a wire can pass therethrough.

Meanwhile, among screws for osteosynthetic treatments, there have been known screws that provide a self-boring or self-drilling function and a self-tapping function. U.S. Pat. No. 5,797,914 entitled “Bone Screw” discloses a screw with self-boring and self-tapping functions, which is used to attach a thin metal bone plate to a bone. In the screw disclosed in '914 patent, a flute is formed at a tip portion thereof, and the profile of a thread adjacent the tip portion is convex, thereby providing self-boring and self-tapping functions. Moreover, U.S. Pat. No. 5,925,048 entitled “Bone Screw” discloses a screw with self-drilling and self-tapping functions, which is used as a fastener for repairing broken bones.

The discussion in this section is to provide general background information, and does not constitute an admission of prior art.

### SUMMARY

A general aspect of the present invention is to provide a screw for medical treatments, which can solve the problems in the prior art.

A primary aspect of the present invention is to provide an anchor screw for orthodontic treatments, which has a head portion enabling tightening or unscrewing of the anchor screw and simultaneously allowing an orthodontic device such as a wire to be hung thereon.

A secondary aspect of the present invention is to provide a screw for medical treatments, which has a body portion capable of increasing a fastening force between the screw and a bone.

It is also possible to provide an anchor screw for orthodontic treatments, which can achieve the both primary and secondary aspects of the present invention by constructing a threaded portion of the anchor screw for orthodontic treatments so as to increase a fastening force between the screw and a bone.

An anchor screw for orthodontic treatments according to an aspect of the present invention includes a threaded portion to be inserted through rotation into the palatine bone or the maxillary so as to form a female thread therein and to fasten the screw to the palatine bone, an intermediate portion extending from the threaded portion and having an increasing diameter, and a head portion extending from the intermediate portion. The head portion has a predetermine width while extending from the intermediate portion and protruding in a direction of a central axis of the anchor screw, and comprises a pair of parallel flat surfaces spaced apart by a predetermined distance from the central axis of the anchor screw to tighten and unscrew the anchor screw, at least one opening formed to penetrate through the pair of flat surfaces so that an orthodontic device including a wire can be installed therein, and an insertion slit extending from an inner surface of the opening facing the threaded portion to the outside so that the opening can communicate with the outside.

Further, in the anchor screw for orthodontic treatments according to the present invention, the threaded portion may be formed with a flute and composed of a plurality of inclined sections so as to impart self-drilling and self-tapping functions and more firmly support an orthodontic device such as a wire. That is, the threaded portion may comprise a tip portion tapered at an included angle about the central axis of the screw, a first body portion extending from the tip portion and having an inclination angle smaller than an inclination angle of the tip portion with respect to the central axis of the screw, and a second body portion extending from the first body portion and having an inclination angle smaller than that of the tip portion but larger than that of the first body portion with respect to the central axis of the screw. A continuous spiral thread may be formed on an outer peripheral surface of the threaded portion from the tip portion to the second body portion. The threaded portion may further comprise a flute formed from the tip portion to the first body portion to cut the bone and remove produced bone fragments so that the female thread can be formed upon insertion of the screw into the bone.

A bone screw for medical treatments according to another aspect of the present invention includes a threaded portion formed with a flute for cutting a bone and discharging produced bone fragments while the threaded portion is inserted through rotation into the bone so as to form a female thread therein, and a head portion extending from the threaded portion. The threaded portion comprises a tip portion tapered at an included angle about the central axis of the screw, a first body portion extending from the tip portion and having an inclination angle smaller than an inclination angle of the tip portion with respect to the central axis of the screw, and a second body portion extending from the first body portion and having an inclination angle smaller than that of the tip portion but larger than that of the first body portion with respect to the central axis of the screw. A continuous spiral thread is formed on an outer peripheral surface of the threaded portion from the tip portion to the second body portion; and the flute is formed over the tip portion and the first body portion.

Further, in the anchor screw for orthodontic treatments or the bone screw for medical treatments according to the present invention, in order to prevent the screw fastened to a bone from being unscrewed, the threaded portion may be configured to ensure that unscrewing torque of the screw becomes larger than tightening torque of the screw. That is, the thread may have a leading angle in a range of 45 to 55 degrees with respect to the central axis of the screw and a trailing angle in a range of 100 to 110 degrees with respect to the central axis of the screw

### BRIEF DESCRIPTION OF THE DRAWINGS

FIG. 1 is a perspective view of an embodiment of an anchor screw for orthodontic treatments according to an aspect of the present invention.

FIG. 2 is a sectional view of the anchor screw taken along line A-A in FIG. 1.

FIG. 3 is a sectional view of the anchor screw taken along line B-B in FIG. 1.

FIG. 4 is a schematic view showing a state where the anchor screw for orthodontic treatments shown in FIG. 1 is used.

FIG. 5 is an explanatory view illustrating a state where the screw of FIG. 4 is threadly engaged with an alveolar bone.

FIG. 6 is a perspective view of an embodiment of a screw for osteosynthetic treatments according to another aspect of the present invention.

BRIEF DESCRIPTION OF REFERENCE NUMERALS

| | |
|---|---|
| 10: Threaded portion | 11: Tip portion |
| 12: First body portion | 13: Second body portion |
| 14: Thread | 15: Flute |
| 20: Intermediate portion | 30: Head portion |
| 31: Base section | 32: Catching protrusion |

### DETAILED DESCRIPTION OF EMBODIMENTS

Generally, an anchor screw for orthodontic treatments is used as a support means for exerting a force on a tooth to be subjected to orthodontic treatments by fixing a thereof becomes larger than tightening torque thereof, thereby maximally preventing unscrewing of the screws from a fastened state.

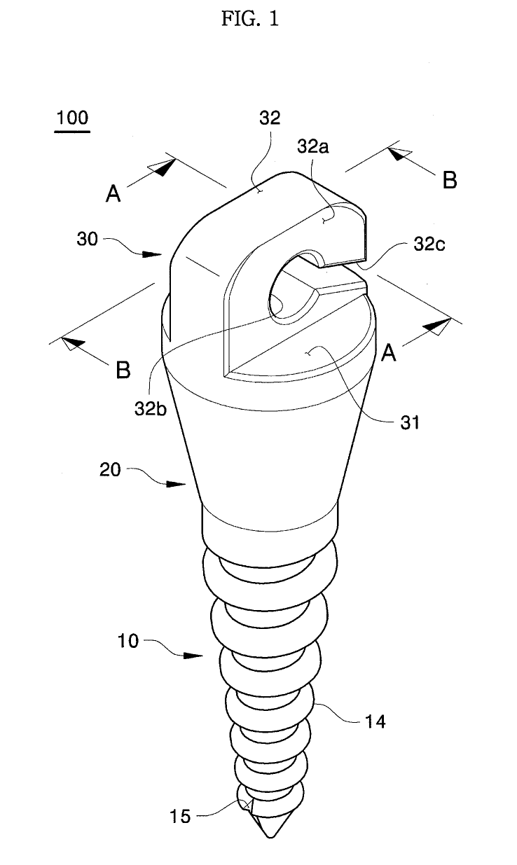

An anchor screw for orthodontic treatments 100 according to an embodiment of the present invention shown in FIG. 1 comprises a threaded portion 10 with a thread formed thereon, an intermediate portion 20 extending from one end of the threaded portion 10 and having an increasing diameter, and a head portion 30 extending from the intermediate portion 20 and having a predetermined width.

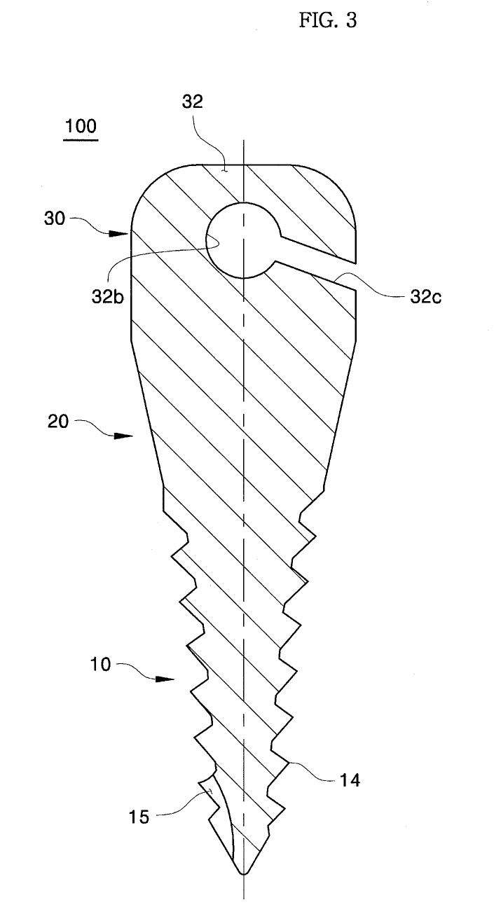

The head portion 30 comprises a base section 31 having the same diameter as the end of the intermediate portion 20 and extending therefrom by a predetermined length, and a catching protrusion 32 extending from the base section 31 in a longitudinal direction of a central axis C and having the predetermined width. The catching protrusion 32 has a pair of parallel flat surfaces 32a and 32a′ spaced apart by a predetermined distance from the central axis C of the anchor screw 100 so as to tighten or unscrew the anchor screw. The catching protrusion further includes at least one opening 32b formed to penetrate through the pair of flat surfaces 32a and an insertion slit 32c for allowing the opening 32b to communicate with the outside, so that an orthodontic device such as a wire can be easily hung on the catching protrusion. The insertion slit 32c is formed such that an outer entrance thereof facing the outside is placed at a level lower than that of an inner exit thereof facing the opening as shown in FIG. 3, thereby preventing the wire, which has been inserted into and caught in the opening 32b, from coming off therefrom.

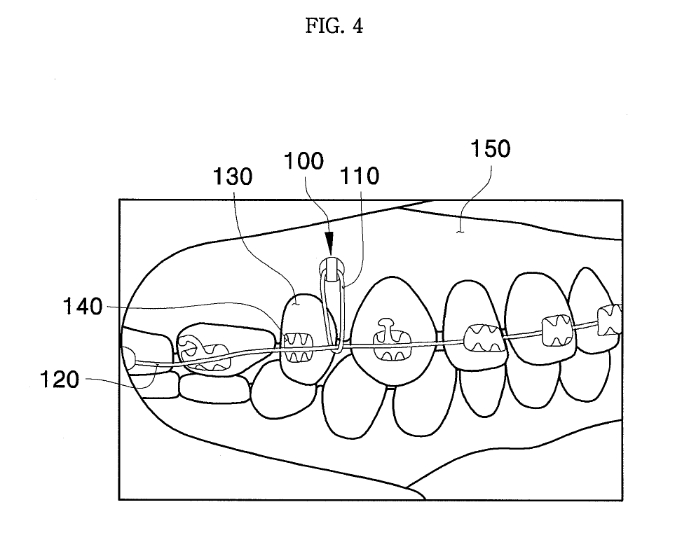

Since the head portion 30 is formed with a “C”-shaped hook in the anchor screw 100 of this embodiment as shown in FIG. 3, a resilient wire can be easily hung on the hook, and the resilient wire hung thereon can be easily removed. Upon use of the anchor screw, as shown in FIG. 4, an end of the resilient wire 110 is hung on the head portion 30 of the anchor screw 100 and the other end of the resilient wire 110 is connected to a wire 120 fixed through a fixing member 140 to a tooth 130 to be subjected to orthodontic treatments, thereby transmitting a force to the tooth 130. Particularly, even though the resilient wire 110 is installed to exert a force in the direction of the central axis C of the screw, the “C”-shaped hook formed in the anchor screw 100 of this embodiment eliminates a risk that the resilient wire may come off therefrom, resulting in convenience in use.

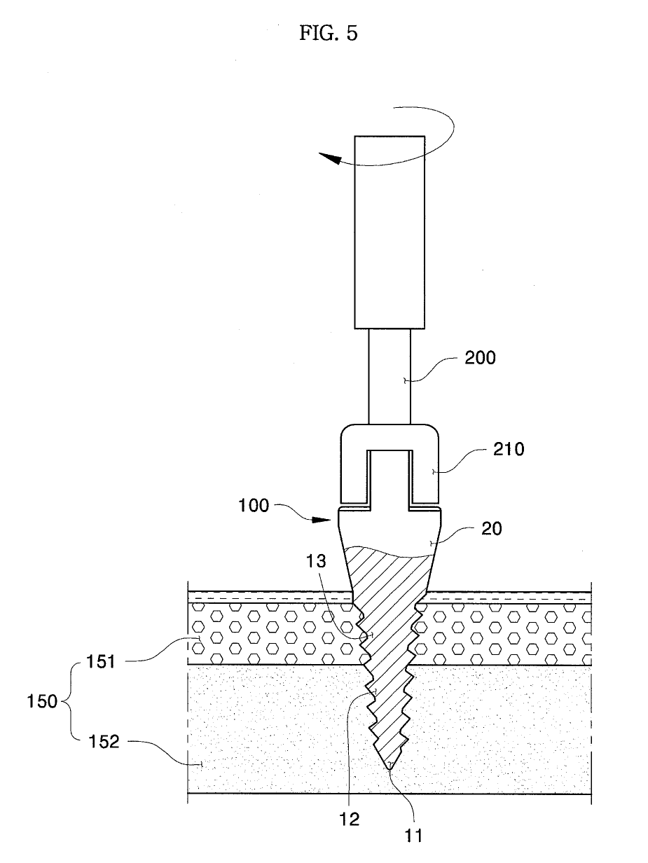

In the anchor screw 100 of this embodiment, as shown in FIG. 5, the pair of parallel flat surfaces 32a and 32a′ spaced apart by the predetermined distance from the central threaded portion of the screw into a jawbone and by hanging an orthodontic device such as a wire on a head portion of the screw. Therefore, the anchor screw for orthodontic treatments should have a structure by which the anchor screw can be strongly fastened to the jawbone and the orthodontic device such as a wire can be easily secured on the head portion of the screw.

In the anchor screw for orthodontic treatments disclosed in U.S. Pat. No. 6,669,473, the orthodontic device such as a wire is not easy to be installed at the central portion such that a force is exerted thereon in an axial direction of the screw. That is, when a loop-shaped end of the wire is hung on and fixed to the reduced diameter zone, there is a possibility that it may come off due to a force exerted thereon in the axial direction of the screw. When the wire is inserted into and fixed to the opening to prevent the wire from coming off, it is difficult to insert the wire into the opening due to the small size of the opening. Further, since a driver should be inserted into a cross-shaped recess on a head portion of the screw to tighten or unscrew the screw, there is inconvenience in installation work.

An exemplary screw for osteosynthetic treatments with the self-drilling and self-tapping functions comprises a tip portion and a body portion, which have a continuous thread formed thereon. The body portion may have a uniform diameter. Further, a flute is formed at the tip portion. Thus, the tip portion digs and enters a bone and the flute allows bone fragments produced by the tip portion to be discharged therethrough, thereby forming a female thread.

However, the uniform diameter of the body portion of the exemplary screw for osteosynthetic treatments may result in a disadvantage of a weak force between the screw and the bone. In the case where the diameter of the body portion is uniform, a fastening force exerted through thread engagement of a threaded portion of the screw with the bone is not distributed to the entire threaded portion but is concentrated on specific regions of the screw and the bone, resulting in a weak fastening force as a whole. Particularly, when the screw with the body portion of a uniform diameter is used as an anchor screw for orthodontic treatments, a weak fastening force between the screw and the bone cannot achieve desired orthodontic treatments if the screw is moved from a position where it is fixed.

Moreover, in screws for orthodontic treatments or screws for osteosynthetic treatments, it may be necessary to design threads of the screws such that unscrewing torque axis C of the anchor screw 100 are used as reference surfaces for use in applying moment for turning the anchor screw 100 so that the anchor screw 100 can be fastened to a bone. That is, the anchor screw 100 can be easily fastened and unscrewed using a tool 200 formed with a recess 210 capable of receiving the catching protrusion 32. It will also be apparent that instead of the use of the pair of flat surfaces 32a and 32a′ of the catching protrusion 32 as the surfaces for use in applying the moment for turning the anchor screw, an outer periphery of the base section 31 of the head portion may be defined such that the base section has a hexagonal cross section to tighten and unscrew the anchor screw.

Further, in the anchor screw 100 of this embodiment, the threaded portion 10 is formed with different inclined sections at three stages to increase a fastening force between the screw 100 and a bone with the screw inserted thereinto. That is, the threaded portion 10 of the anchor screw for orthodontic treatments 100 of this embodiment comprises a tip portion 11 tapered at an included angle 2α about the central axis C of the screw 100, a first body portion 12 extending from the tip portion 11, and a second body portion 13 extending from the first body portion 12. Further, the threaded portion 10 is formed with a continuous spiral thread 14 from the tip portion 11 to the second body portion 13.

The included angle 2α of the tip portion 11 performs a drilling function by which a bore can be formed in a bone, and is preferably in a range of 35 to 45 degrees. An inclination angle β of the first body portion 12 with respect to the central axis C is smaller than an inclination angle α of the tip portion 11 with respect to the central axis C. Further, an inclination angle γ of the second body portion 13 with respect to the central axis C is smaller than the inclination angle α of the tip portion 11 with respect to the central axis C but larger than the inclination angle β of the first body portion 12 with respect to the central axis C. Therefore, as shown in FIG. 5, the threaded portion 10 threadly engaged with a bone 150 has a diameter increasing toward the head portion 30. This results in uniform distribution of load throughout the screw.

Particularly, in the anchor screw 100 of this embodiment constructed as above, the first body portion 12 penetrates a strong outer layer 151 of the bone 150 and is then contained in and supported by a soft inner layer 152 of the bone 150. To reduce resistance, the inclination angle β of the first body portion 12 is set to be smaller than those of the tip portion 11 and the second body portion 13. Moreover, since the inclination angle γ of the second body portion 13 is set to be larger than the inclination angle β of the first body portion 12, the second body portion 13 with a diameter larger than that of the first body portion 12 is supported by the strong outer layer 151 of the bone. Thus, the entire screw 100 uniformly distributes and firmly supports external load throughout the tip portion 11, the first body portion 12 and the second body portion 13. Accordingly, the threaded portion 10 of the anchor screw 100 of this embodiment distributes and supports the load by means of the three-stage inclinations, thereby increasing a fastening force between the screw and the bone.

Further, to perform self-drilling and self-tapping functions when the anchor screw for orthodontic treatments 100 of this embodiment is inserted into an alveolar bone, a flute 15 is formed over the tip portion 11 and the first body portion 12. When the screw 100 is inserted into the bone while being turned, the flute 15 cuts the bone to form a female thread and allows produced bone fragments to be discharged along the thread 14 to the outside.

In the anchor screw 100 of this embodiment, the thread 14 has a leading angle δ1 and a trailing angle δ2, which are selected to ensure that unscrewing torque of the screw becomes larger than tightening torque of the screw in order to prevent the screw from being unscrewed. The leading angle δ1 of the thread 14 with respect to the central axis C of the screw 100 is preferably in a range of 45 to 55 degrees, and the trailing angle δ2 of the thread 14 with respect to the central axis C of the screw 100 is preferably in a range of 100 to 110 degrees.

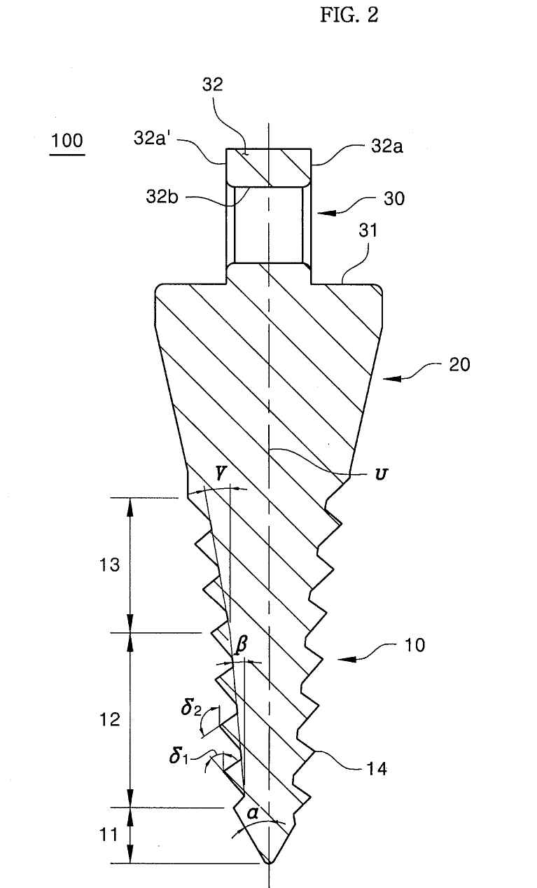

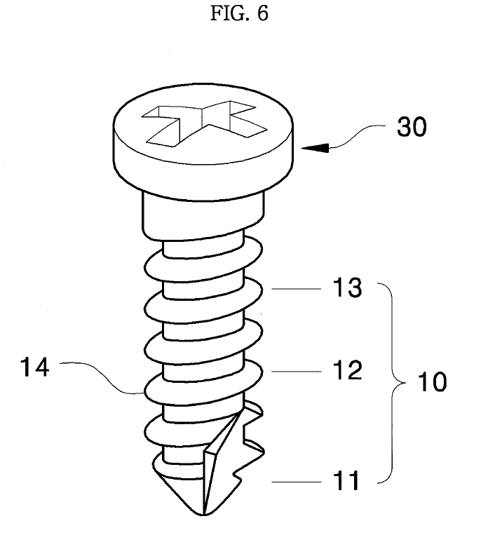

FIG. 6 shows a perspective view of a screw for osteosynthetic treatments according to another aspect of the present invention. This embodiment is different from the embodiment of FIG. 1 in that there are no intermediate portion and “C”-shaped head portion on which a wire is to be hung. According to this embodiment, a conventional screw for osteosynthetic treatments with self-drilling and self-tapping functions is modified to include a threaded portion 10 with three-stage inclinations as shown in FIG. 2. That is, the threaded portion 10 comprises a tip portion 11 tapered at an included angle 2α about a central axis C of the screw, a first body portion 12 extending from the tip portion 11, and a second body portion 13 extending from the first body portion 12. Further, the threaded portion 10 is formed with a continuous spiral thread 14 from the tip portion 11 to the second body portion 13. Moreover, an inclination angle β of the first body portion 12 with respect to the central axis C is smaller than an inclination angle α of the tip portion 11 with respect to the central axis C, and an inclination angle γ of the second body portion 13 with respect to the central axis C is smaller than the inclination angle α of the tip portion 11 with respect to the central axis C but larger than the inclination angle β of the first body portion 12 with respect to the central axis C. Therefore, the threaded portion 10 threadly engaged with a bone 150 has a diameter increasing toward the head portion 30. This results in uniform distribution of load throughout the screw. Compared with conventional screws for osteosynthetic treatments, stronger coupling can be achieved between the screw and the bone.

Furthermore, to prevent unscrewing after the screw of this embodiment has been fastened, the thread 14 is configured to have a leading angle and a trailing angle that are in the same ranges as the leading and trailing angles in the embodiment of FIG. 2.

According to the present invention, there is provided an anchor screw for orthodontic treatments, which has a head portion enabling easy installation and removal of a resilient wire and tightening and unscrewing of the screw, and a thread portion with three-stage inclinations for increasing a fastening force between the screw and the palatine bone. Therefore, a force can be accurately exerted on a tooth to be treated in a desired direction and with a desired amplitude, so that a dentist can more easily perform orthodontic treatments and more firmly fix the anchor screw, resulting in shortened time for orthodontic treatments.

According to the present invention, there is provided a screw for osteosynthetic treatments, which has a threaded portion with three-stage inclinations. The threaded portion with three-stage inclinations increases a fastening force between the screw and a bone with the screw inserted thereinto, thereby ensuring stronger bonesetting of fractured bones.

It is intended that the embodiments of the present invention described above and illustrated in the drawings should not be construed as limiting the technical spirit of the present invention. The scope of the present invention is defined only by the appended claims. It is apparent that those skilled in the art can make various changes and modifications thereto. Therefore, such changes and modifications fall within the scope of the present invention so far as they are obvious to those skilled in the art.

What is claimed is:

1. An anchor screw for orthodontic treatments, including a threaded portion to be inserted through rotation into the palatine bone or the maxillary so as to form a female thread therein and to fasten the screw to the palatine bone, an intermediate portion extending from the threaded portion and having an increasing diameter, and a head portion extending from the intermediate portion, wherein:
the head portion has a predetermine width while extending from the intermediate portion and protruding in a direction of a central axis of the anchor screw, and comprises a pair of parallel flat surfaces spaced apart by a predetermined distance from the central axis of the anchor screw to tighten and unscrew the anchor screw, at least one opening formed to penetrate through the pair of flat surfaces so that an orthodontic device including a wire can be installed therein, and an insertion slit extending from an inner surface of the opening facing the threaded portion to the outside so that the opening can communicate with the outside.

2. The anchor screw according to claim 1, wherein the threaded portion comprises a tip portion tapered at an included angle about the central axis of the screw, a first body portion extending from the tip portion and having an inclination angle smaller than an inclination angle of the tip portion with respect to the central axis of the screw, and a second body portion extending from the first body portion and having an inclination angle smaller than that of the tip portion but larger than that of the first body portion with respect to the central axis of the screw;
a continuous thread is formed on an outer peripheral surface of the threaded portion from the tip portion to the second body portion; and
the threaded portion further comprises a flute formed from the tip portion to the first body portion to cut the bone and discharge produced bone fragments so that the female thread can be formed upon insertion of the screw into the bone.

3. The anchor screw according to claim 2, wherein the thread has a leading angle in a range of 45 to 55 degrees with respect to the central axis of the screw and a trailing angle in a range of 100 to 110 degrees with respect to the central axis of the screw to ensure that unscrewing torque of the screw becomes larger than tightening torque of the screw.

4. A bone screw for medical treatments, including a threaded portion formed with a flute for cutting a bone and discharging produced bone fragments while the threaded portion is inserted through rotation into the bone so as to form a female thread therein, and a head portion extending from the threaded portion, wherein:
the threaded portion comprises a tip portion tapered at an included angle about the central axis of the screw, a first body portion extending from the tip portion and having an inclination angle smaller than an inclination angle of the tip portion with respect to the central axis of the screw, and a second body portion extending from the first body portion and having an inclination angle smaller than that of the tip portion but larger than that of the first body portion with respect to the central axis of the screw;
a continuous spiral thread is formed on an outer peripheral surface of the threaded portion from the tip portion to the second body portion; and
the flute is formed over the tip portion and the first body portion.

5. The anchor screw according to claim 4, wherein the thread has a leading angle in a range of 45 to 55 degrees with respect to the central axis of the screw and a trailing angle in a range of 100 to 110 degrees with respect to the central axis of the screw to ensure that unscrewing torque of the screw becomes larger than tightening torque of the screw.
